(19) United States
(12) Patent Application Publication
(10) Pub. No.: US 2009/0323728 A1
(43) Pub. Date: Dec. 31, 2009

(54) ASYNCHRONOUS DATA FIFO THAT PROVIDES UNINTERRUPTED DATA FLOW

(75) Inventors: Dennis Koutsoures, Glendale Heights, IL (US); Ivan Svestka, North Riverside, IL (US)

Correspondence Address: NXP, B.V.;NXP INTELLECTUAL PROPERTY & LICENSING, M/S41-SJ, 1109 MCKAY DRIVE, SAN JOSE, CA, 95131, US

(73) Assignee: NXP B.V., Eindhoven (NL)

(21) Appl. No.: 12/306,907

(22) PCT Filed: Jun. 21, 2007
(86) PCT No.: PCT/IB07/52402

§ 371 Date: Dec. 29, 2008

Related U.S. Application Data
(60) Provisional application No. 60/817,958, filed on Jun. 30, 2006.

(30) Foreign Application Priority Data
Jun. 21, 2007 (IB) PCT/IB2007/052402

(51) Int. Cl. H04J 3/06; G06F 12/00

(52) U.S. Cl. 370/503; 711/109; 711/E12.001

(57) ABSTRACT

An asynchronous FIFO is provided that determines whether its buffer is primed with at least one data element during a data transfer across clock domains in order to eliminate metastability issues that cause data stalls and interruptions in data flow.

### BACKGROUND OF THE INVENTION

Embodiments of the present invention are related to asynchronous data FIFOs. In particular, embodiments of the present invention are related to asynchronous data FIFOs that ensure that enough data is in a FIFO buffer such that effects of a synchronization stall are averted because the FIFO has at least one data element within its buffer.

It is common for packet based digital systems to send and receive data across clock domains. Such packet based digital systems usually require an uninterrupted data flow after a packet of data in the communication begins to be sent. Once the packet is in transit between two systems having different clock domains, the packet cannot be throttled or interrupted by any external means.

One known method for sending packets of data between digital systems having different clock domains is to use an asynchronous FIFO. A typical asynchronous FIFO requires synchronization of the packet based digital data as the data moves from one clock domain to another clock domain. Obtaining such synchronization sometimes leads to an interruption in the data flow between the two clock domains. One reason an interruption may occur is because the two clock domain's clock edges are very near, in time, to one another and thus result in synchronization slippage due to the hold times of one or more flip-flops. The slippage is seen as a temporary stall in the data that is available at the read side of the asynchronous FIFO. Such a slippage potentially, and in many cases, results in an interruption of the data flow.

What is needed is a mechanism for achieving uninterrupted data flow through an asynchronous FIFO. By obtaining an uninterrupted data flow through a FIFO, the effects of data slippage through the FIFO can be completely alleviated.

### BRIEF SUMMARY OF THE INVENTION

In order to overcome the above indicated problems, as well as others, some embodiments of the present invention describe an asynchronous data FIFO that provides uninterrupted data flow. The data flow does not suffer from metastability issues common to other asynchronous FIFOs, such as data stalls and data flow interruptions. The asynchronous FIFOs according to the embodiments comprise novel synchronization circuitry, and buffer level decision circuitry that determines whether any data elements are in the FIFO's data buffer when a new data packet arrives at the FIFO's data buffer input.

In one embodiment having an asynchronous FIFO, a FIFO buffer is provided for receiving data from a data input. The buffer may also receive a start bit that is coincident with receipt of the beginning of a new data packet. Circuitry is included that determines the level of data in the buffer. The circuitry provides a read-data-ready signal at an output of the asynchronous FIFO when the start bit is not asserted at the beginning of a new data packet and the level of data in the buffer is greater than zero (0). Furthermore, the circuitry provides a read-data-ready signal when the start bit is asserted at the beginning of a new data packet and the level of data in the buffer is greater than one (1). The start bit or bits may be the first bit(s) of the new data packet.

The circuitry that determines the level or amount of data in the buffer may comprise a read level comparison circuit that compares a synchronized write gray code pointer and a read gray code pointer and then provide a level indication output to a multiplexer such that when the start bit is not asserted, the multiplexer provides the read-data-ready signal if the read level comparison circuit's output indicates there is more than zero (0) data elements in the buffer. When the start bit is asserted the multiplexer provides the read-data-ready signal if the comparison circuit's output indicates that there is more than one (1) data elements in the buffer.

In other embodiments of the invention, the circuitry that determines the amount or level of data in the buffer ensures that there is enough data in the buffer, when new packet/data is received by the asynchronous FIFO to avoid a data slippage or interruptions in the output of the FIFO.

In yet another embodiment of the invention and asynchronous FIFO is provided that comprises a FIFO buffer that receives data from a data input and that provides data to a data output in a first-in-first-out order. A circuit is included that calculates when a read-data-ready signal should be asserted by the asynchronous FIFO. The circuit determines whether more than one data element is in the FIFO buffer when a new packet/data element is being received by the FIFO buffer before asserting the read-data-ready signal.

By determining whether the buffer has any data elements contained therein when receiving new packet/data at the input of the buffer, embodiments of the invention make sure that a data stall, data interruption, or other data flow problem caused by a metastability issue does not occur because the buffer will always have at least one data element in it that is ready to be provided as an output if a data stall or interruption occurs in the FIFO's synchronization circuitry due to a flip-flop set-up or hold time problem caused by edges of the asynchronous clock signals be very close in time.

It should be understood that this summary does not summarize all the different possible embodiments or working of the invention.

### BRIEF DESCRIPTION OF THE DRAWINGS

A more complete understanding of the method and apparatus of the present invention may be obtained by reference to the following detailed description when taken in conjunction with the accompanying drawings wherein:

FIG. 1 shows a block diagram of a typical asynchronous FIFO architecture;

FIG. 2 shows a block diagram of a synchronizer found in a asynchronous FIFO architecture; and

FIG. 3 shows a block diagram of an enhanced asynchronous FIFO in accordance with an embodiment of the present invention.

### DETAILED DESCRIPTION OF THE INVENTION

FIFO is an acronym for first in, first out. The expression describes the principal of a queue or first-come-first-served behavior. Whatever comes in first is handled first, whatever comes in next waits until the first piece of data is finished being handled.

Asynchronous communication is generally the sending and receiving of data without synchronizing both the data sending device and the data receiving device to an external clock. In general, an asynchronous communication technique is considered a physical layer transmission technique that is widely used for personal computers providing connectivity to printers, modems, fax machines, etc. The most significant aspect of asynchronous communications is that the transmitting circuitry's clock and the receiving circuitry's clock are independent of each other and are not synchronized. An asynchronous circuit generally is a circuit in which a circuit is clocked substantially autonomously from another circuit. For example, a transmitting circuit and a receiving circuit are not governed by a single clock circuit or global clock signal, but instead need only wait for the signals that indicate completion of instructions and operation. These signals are generally specified in the particular data transfer protocols. In contrast to an asynchronous circuit, a logic circuit design that is synchronous is one wherein all the circuitry within the circuit operates according to a single set of clock timing signals.

One problem that occurs when attempting to synchronize data to a new clock in an asynchronous FIFO is the problem of metastability. Metastability is the name for the physical phenomenon that happens when an event tries to sample another event. In physical systems, the provision of data that is clocked at a first frequency by a sending device and is received and sampled at a receiving device at a second clock frequency yields unpredictable results. Unpredictability leads to the danger that metastability poses. With respect to D flip-flops, the Q resolves itself to the value of D. The time required for this resolve is called the resolution time. If the setup time and hold time of a flip-flop are met, then the resolution time of the flip-flop is accounted for and the output of the flip-flop will be resolved. Metastability affects the resolution time of the physical device or system, as well as the resolved value. One can think of metastability in terms of an “unstable equilibrium.”

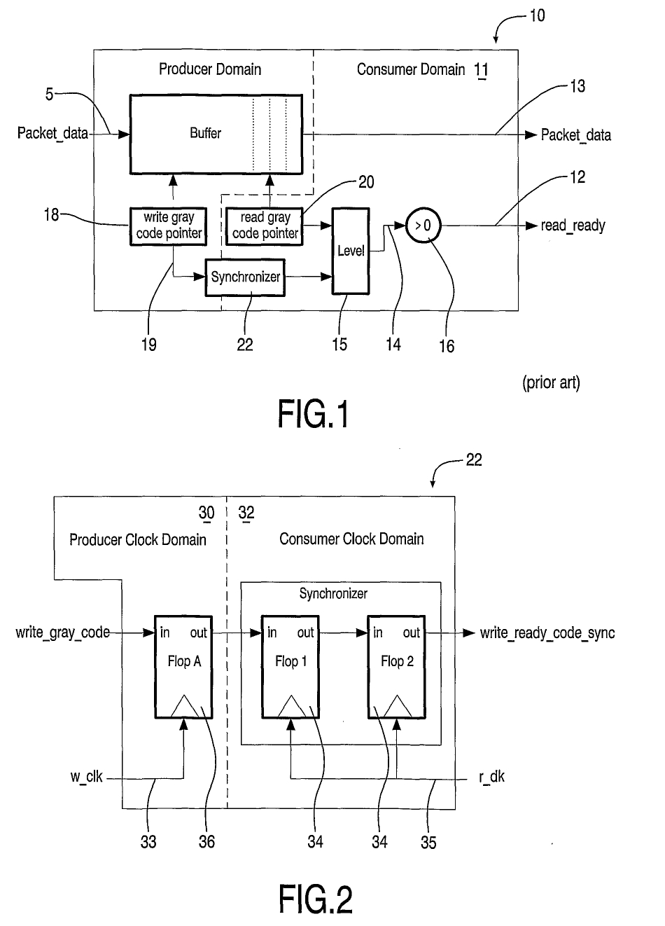

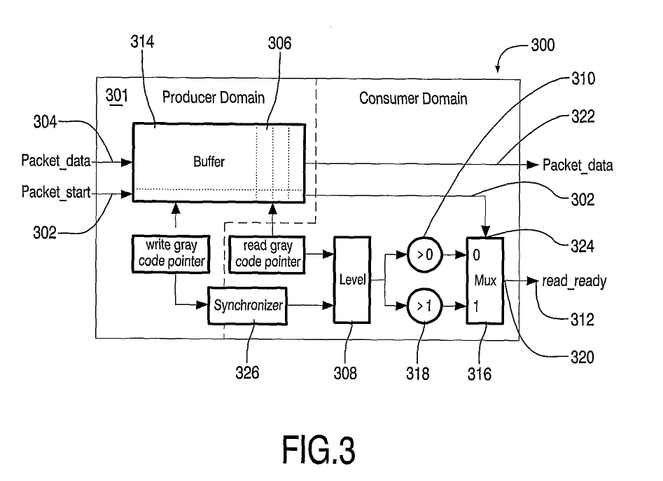

In FIG. 1 an asynchronous FIFO 10 is shown. An asynchronous FIFO 10 typically has a read data ready indicator 12 in the read domain 11 (consumer domain). This read data ready indicator 12, as the name implies, informs the receiving circuitry (not shown) when data 9 (9 does not appear to be on FIG. 1), on the data output 13, is available for consumption. The read data ready indicator 12 is generated from an internal read domain FIFO level signal 14. Whenever the data level calculation circuit 15 determines that the read domain FIFO level is greater than zero 16, then data for reading is available on the data output 13. The FIFO level signal 14 is generated from a synchronized write gray code data pointer 18 and a read gray code data pointer 20. A write gray code pointer synchronizer 22 receives the write gray code pointer signal 19. The synchronizer 22 aids in synchronizing the input signal 19 with the clock of the receiving circuitry. The write gray code pointer synchronizer 22 consists of two tiers of flip-flops, which are depicted in FIG. 2.

Referring now to FIG. 2, as long as the producer of the data supplies more data than the receiver of the data can process then data slippage, in theory, should not be a problem. This implies that the write clock 33 in the clock domain of the data provider or producer (producer clock domain) 30 is faster than the read clock 35 in the clock domain of the recipient of the data (the consumer clock domain) 32. However, inevitably from time to time a producer's write domain clock edge will align with the consumers read domain clock edge. When this alignment occurs the synchronizer's flip-flops 34 may miss their opportunity to capture the data provided to flip-flop A 36 due to the flip-flop A's hold requirements. This is a classic example of metastability. The miss of the capturing of the data from flip-flop a 36 will result in the data being sampled by the synchronizer 22 one read clock cycle later. The one read clock delay is what is called a stall on the read interface and will be seen if the read FIFO level is a one at the time of the slippage. This behavior is both common and normal in a typical asynchronous FIFO 10.

In various embodiments of the present invention a mechanism that removes the effects of a synchronizer's slippage, the problems caused by metastability, and the resulting read domain stalls during packet transmission is provided. By removing the effects of synchronizer slippage, metastability, and the read domain stalls, embodiments of the present invention provide an uninterrupted packet/data flow between the data producing device and the data receiving device when both devices are operating asynchronously.

Embodiments of the present invention provide a novel modification to the typical asynchronous FIFO that changes how the read data ready indicator is calculated. Since the data producing device or system is communicating using packets to start off any transfer of data then the beginning of the transfer of data is generally known. A packet start, data start or start bit (hereinafter start bit) signal can be provided from the data producing device or generated with the start of a data transfer.

Referring to FIG. 3, an enhanced asynchronous FIFO 300 in accordance with an embodiment of the invention is shown. A data producing device or system provides or writes a start bit on the packet start line 302. The start bit is coincident with the beginning of the data that is being written to the FIFO 300 on the packet data line 304. The data being written into the FIFO 300 is being provided to the buffer 314. A read level comparison is made in the level comparison circuit 308 wherein a synchronized write gray code pointer output is compared with a read gray code pointer output in order to provide a read level comparison signal.

In the producer/write domain 307, the start bit on line 302 may be used to prime the read data buffers within the buffer 314. That is, if the start bit is not set when a current packet data to be read is present at the front 306 of the FIFO buffer 314 and the read FIFO level 308 is greater than zero 310, then the output 320 of the multiplexer 316 will provide a read data ready indicator on the read ready line 312. Furthermore, if the start bit is set with the current read data to be read present at the front 306 of the FIFO buffer 314 while the read FIFO level 308 determines that the level is greater than one 318, then the read data indicator should also be asserted on the read ready line 312 at the output 320 of the multiplexer 316. Operating the FIFO 300 in this manner, ensures that enough data is primed in the FIFO buffer 314 such that any effects from a metastable synchronization stall are averted because the FIFO 300 will always have at least one data element in its buffer 314 ready to be provided as packet data output 322 if a data slippage occurs.

In some embodiments of an improved asynchronous FIFO 300, the width of a data packet will be expanded by one bit to accommodate the packet start bit. Such an embodiment may also require a single multiplexer 316 having a selector 324 that receives the newly added start bit from the packet start line 302. When the start bit is not asserted on the multiplexer 316, the multiplexer will select the result of the read level comparison (write gray code/read gray code) for greater than one 318. The output 320 of the multiplexer 316 drives the read data ready indicator provided by the read ready line 312.

Embodiments of the present invention were tested with the buffer 314 having at least one data element that could be provided as output from the FIFO 300 if the flip-flops, within the synchronizer 326, miss capturing data from flip-flop A 36 within the flip-flops' set-up and/or hold time requirements. (See FIG. 2) Thus when data is missed, the buffer of an embodiment of the present invention can contain at least one data element that could be read from an enhanced asynchronous FIFO 300 while synchronization is reestablished.

Embodiments of the present invention help improve data transfer in asynchronous situations. Where various devices are operating asynchronously and uninterrupted packet/data flow is desired between the devices, then such a need can be met with embodiments of the present invention. An asynchronous FIFO helps provide data transfer benefits because data flow stalls, and metastability issues can be resolved while data transfer rates can remain maximized. Many variations and embodiments of the above described invention and method are possible. Although only certain embodiments of the invention and method have been illustrated in the accompanied drawings and described in the foregoing detailed description, it will be understood that the invention is not limited to the embodiments disclosed, but is capable of additional rearrangements, modifications, and substitutions without departing from the invention as set forth and defined by the following claims. Accordingly, it should be understood that the scope of the present invention encompasses all such arrangements and is solely limited by the appended claims.

1. An asynchronous FIFO comprising:
a FIFO buffer for receiving data from a data input said buffer receives a start bit that is coincident with receipt of a new data at said data input;
circuitry for determining a level of data in said FIFO buffer, said circuitry provides a read-data-ready signal at an output of said asynchronous FIFO when:
said start bit is not asserted with a coincident new data and said level of data in said FIFO buffer is greater than 0; and when,
said start bit is asserted with said coincident new data, and said level of data in said FIFO buffer is greater than 1.

2. The asynchronous FIFO of claim 1, wherein said start bit is read by said asynchronous FIFO at the same time as said new data is present an input to said FIFO buffer.

3. The asynchronous FIFO of claim 1, wherein said circuitry for determining a level of data in said FIFO buffer comprises,
a read level comparison circuit that compares a synchronized write gray code pointer with a read gray code pointer and provides a read level comparison signal;
a multiplexer that receives said start bit as a selector bit such that when said start bit is not asserted, said multiplexer provides said read-data-ready signal if said read level comparison signal is greater than 0, and such that when said start bit is asserted, said multiplexer provides said read-data-ready signal if said read level comparison signal is greater than 1.

4. The asynchronous FIFO of claim 1, wherein said circuitry ensures that enough data is in said FIFO buffer when said new data is being received by said FIFO buffer to avoid a data slippage in an output of said FIFO.

5. The asynchronous FIFO of claim 1, wherein said read-data-ready signal is not asserted, when the start bit is asserted and the level of data in the FIFO buffer is 0, so that an interruption in data flow, due to an asynchronous write clock edge and an asynchronous read clock edge that are within a hold time of a flip-flop in a synchronizer circuit of said asynchronous FIFO does not occur.

6. The asynchronous FIFO of claim 1, wherein said new data is packet data.

7. An asynchronous FIFO comprising:
a FIFO buffer for receiving data from a data input and for providing data to a data output in a first-in-first-out order;
a circuit for calculating when a read-data-ready signal is to be asserted by said asynchronous FIFO, said circuit determines that more than one data element is in said FIFO buffer when a first new data element is being received by said FIFO buffer before asserting said read-data-ready signal.

8. The asynchronous FIFO of claim 7, wherein said first new data element is a first data element of a data packet.

9. The asynchronous FIFO of claim 7, wherein said circuit receives a start bit signal coincident with said first new data element.

10. The asynchronous FIFO of claim 7, wherein said circuit comprises at least one flip-flop and wherein said circuit eliminates a data slippage due to a synchronization stall caused by the two asynchronous clock domain's signal edge's being within a hold time of said at least one flip-flop.

11. The asynchronous FIFO of claim 7, wherein said circuit comprises at least one synchronization circuit that receives two asynchronous data clock signals and wherein said circuit further comprises a decision circuit that eliminates metastability in the asynchronous FIFO.

12. The asynchronous FIFO of claim 7, wherein said circuit determines that said read-data-ready signal is to be asserted when one or more data elements are in said FIFO buffer and a data element, other than said first new data element, is being received by said FIFO buffer.

13. The asynchronous FIFO of claim 12, wherein a start bit is not being asserted while said data element is being received by said FIFO buffer.

14. A method of removing affects of synchronizer slippage and read domain stalls during data packet transmission through an asynchronous FIFO, said method comprising:
receiving data packets by a buffer in said asynchronous FIFO, said data packets being received in association with a first clock signal, each one of said data packets comprising a first data element at the beginning of each said data packet and a plurality of data elements following said first data element;
receiving a start bit signal at a second input of said asynchronous FIFO, said start bit signal being asserted at times that coincide with a beginning of said first data elements of said data packets;
providing an asserted read-data-ready signal at a first output of said asynchronous FIFO only when a read FIFO level is greater than one while said start bit is asserted or only when said read FIFO level is greater than zero while said start bit is not asserted; and
providing said data packets to be read at a second output of said asynchronous FIFO, said data packets being provided in association with a second clock signal, said data packets to be read are provided without affects from synchronizer slippage and read domain stalls while said read-data-read signal is asserted.

15. The method of claim 14, wherein said start bit signal comes from said beginning of said first data elements of said data packets.

16. A method of removing affects of synchronizer slippage and read domain stalls during data packet transmission through an asynchronous FIFO, said method comprising:
receiving data packets by a buffer in said asynchronous FIFO, said data packets being received in association with a first clock signal, each one of said data packets comprising a first data element at the beginning of each said data packet and a plurality of data elements following said first data element;
providing a read-data-ready signal at a first output of said asynchronous FIFO only when said data packets can be read from said buffer of said asynchronous FIFO without an interruption of data flow.

17. The method of claim 16, wherein said interruption of data flow is caused by at least one of effects of synchronizer slippage and effects of read domain stalls.

18. The method of claim 16, wherein said providing further comprises providing said read-data-ready signal at said first output when a read FIFO level is greater than one while a start bit is asserted and only when said read FIFO level is greater than zero while said start bit is not asserted.

19. The method of claim 16, wherein said providing further comprises providing said read-data ready signal at said first output when enough data elements are in said buffer so that an affect of a synchronization stall in said asynchronous FIFO is averted.
